(19) United States
(12) Patent Application Publication
(10) Pub. No.: US 2026/0014883 A1
(43) Pub. Date: Jan. 15, 2026

(54) ELECTRIC VEHICLE CHARGING STATING HAVING A DRAINAGE SYSTEM

(71) Applicant: VOLTA CHARGING, LLC, San Francisco, CA (US)

(72) Inventors: Alexei Kian SAMIMI, Bellingham, WA (US); Anant SHAH, San Ramon, CA (US)

(21) Appl. No.: 18/994,569

(22) PCT Filed: Jun. 14, 2023
(86) PCT No.: PCT/US2023/068453

§ 371 Date: Jan. 14, 2025

Related U.S. Application Data
(60) Provisional application No. 63/394,883, filed on Aug. 3, 2022.

(51) Int. Cl. B60L 53/31

(52) U.S. Cl. CPC B60L 53/31

(57) ABSTRACT

An electric vehicle charging station having a frame at least partially defining an interior space, a door rotatably coupled to the frame to provide access to the interior space when in an open position and to prevent access to the interior space when in a closed position, and a gutter disposed at least partially within the interior space to divert precipitation away from the electric vehicle charging station.

### TECHNICAL FIELD

This application relates generally to electric vehicle charging stations and, more particularly, to electric vehicle charging stations having a drainage system.

### BACKGROUND

Electric vehicles are growing in popularity, largely due to their reduced environmental impact and lack of reliance on fossil fuels. These vehicles, however, typically need to be charged more frequently than a gas-powered vehicle would need to be refueled (e.g., every 100 miles as opposed to every 400 miles). As such, the availability of electric vehicle charging stations plays a significant role in users' decisions about where to travel.

Electric vehicle charging stations are becoming more prevalent as electric vehicles are being used more and for longer distances. Electric vehicle charging stations are often installed or placed outdoors with minimal cover to provide easy access to a user of an electric vehicle. This results in the electric vehicle charging stations being exposed to the elements. Outdoor electric vehicle charging stations that encounter precipitation (including rain), may be damaged if the interior of the charging station is exposed to the precipitation. As such, it is desirable for electric vehicle charging stations to be able to divert any precipitation away from the station.

### SUMMARY

One embodiment of the present disclosure provides an electric vehicle charging station having a frame at least partially defining an interior space, a door rotatably coupled to the frame to provide access to the interior space when in an open position and to prevent access to the interior space when in a closed position, and a gutter disposed at least partially within the interior space to divert precipitation away from the electric vehicle charging station.

In some embodiments, the electric vehicle charging station further includes a gasket disposed between the door and the frame, where the gasket forms an at least partial seal between at least a portion of the frame and at least a portion of the door in the closed position, and wherein the gutter is configured to divert precipitation that bypasses the gasket away from the electric vehicle charging station. In some embodiments, the gutter includes an inner edge proximate the frame and an outer edge proximate the door. In some embodiments, the inner edge is substantially parallel to the outer edge for a majority of a length of the gutter. In some embodiments, at least one of the inner edge and the outer edge tapers towards one another at a longitudinal end of the gutter.

In some embodiments, the gasket is coupled to the door. In some embodiments, the gasket is coupled to the frame.

In some embodiments, in the closed position, a top edge of the door abuts a substantially vertical top wall of the frame. In some embodiments, the top wall of the frame is illuminated.

In some embodiments, the electric vehicle charging station further includes a deflector disposed in the interior space under the top wall of the frame to deflect into the gutter any precipitation that enters the interior space from between the top wall of the frame and the top edge of the door when the door is in the closed position.

In some embodiments, the electric vehicle charging station further includes a gasket coupled to the door and abutting the top wall of the frame when the door is in the closed position, wherein the deflector is coupled to the top wall such that at least a portion of the deflector is disposed between the gasket and the gutter, the deflector configured to deflect the precipitation to the gutter.

In some embodiments, the gutter is substantially parallel to the top edge of the door.

In some embodiments, the electric vehicle charging station further includes a downspout coupled to the frame, the downspout being fluidly connected to the gutter to discharge the precipitation away from the electric vehicle charging station near a base of the frame. In some embodiments, the downspout is substantially perpendicular to the gutter.

In some embodiments, the electric vehicle charging station further includes a camera disposed within the interior space with a lens pointed through a camera opening in the door. In some embodiments, the camera is in the interior space and above the gutter.

In some embodiments, the door includes an interior surface, an exterior surface opposite the interior surface, a window extending through the door from the interior surface to the exterior surface, and a display screen mounted to the interior surface and viewable through the window.

In some embodiments, the gutter is coupled to the frame. In some embodiments, the gutter is coupled to the door.

In some embodiments, the electric vehicle charging station further includes an additional door coupled to the frame, the additional door being disposed on an opposite side of the frame to the door.

In some embodiments, a proximal end of the gutter is disposed higher than a distal end of the gutter such that the proximal end of the gutter is proximate a top wall of the frame compared to the distal end of the gutter.

Another embodiment of the present disclosure provides an electric vehicle charging station having a frame at least partially defining an interior space, the interior space housing one or more electrical components configured to provide charge to an electric vehicle, a door rotatably coupled to the frame, the door having a top edge and a side edge, the door having an open position allowing access to the interior space and a closed position preventing access to the interior space, a gasket disposed along at least a portion of the top edge and a portion of the side edge, wherein the gasket abuts the frame to form a seal between the portion of the top edge and the frame when the door is in the closed position, a gutter including an outer edge and an inner edge and the gutter extending across at least a portion of a width of the door, the gutter disposed within the interior space and proximate the gasket when the door is in the closed position, the outer edge being tapered towards the inner edge at a distal end of the gutter, and a downspout coupled to the frame proximate the distal end of the gutter, the downspout being substantially perpendicular to the gutter when coupled to the frame.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1 is a side view of an electric vehicle charging station in accordance with some embodiments of the present disclosure.

FIG. 2 is a front view of the electric vehicle charging station of FIG. 1

FIG. 3 is a zoomed in oblique view of portion of the electric vehicle charging station of FIG. 1.

FIG. 4 is an oblique cross-sectional view of a portion of the electric vehicle charging station of FIG. 1.

FIG. 5 is a different oblique cross-sectional view of a portion of the electric vehicle charging station of FIG. 1.

FIG. 6 is another oblique cross-sectional view of a portion of the electric vehicle charging station of FIG. 1.

FIG. 7 is an oblique cross-sectional view of a portion of the electric vehicle charging station of FIG. 1.

FIG. 8 is a cross-sectional front view of the electric vehicle charging station of FIG. 1.

FIG. 9 is a cross-sectional front perspective view of a portion of the electric vehicle charging station of FIG. 1.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Many modifications and variations of this disclosure can be made without departing from its spirit and scope, as will be apparent to those skilled in the art. The specific embodiments described herein are offered by way of example only, and the disclosure is to be limited only by the terms of the appended claims, along with the full scope of equivalents to which such claims are entitled.

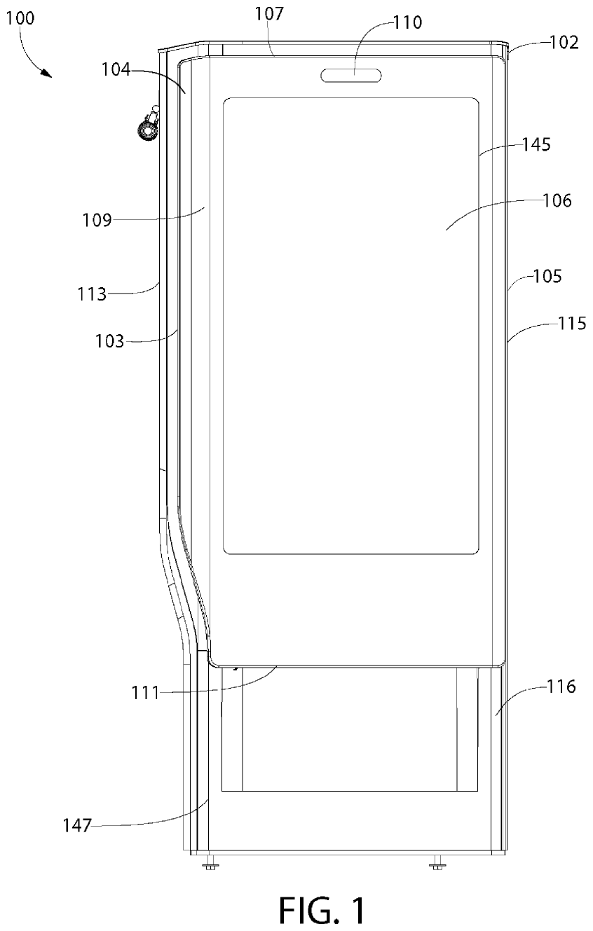

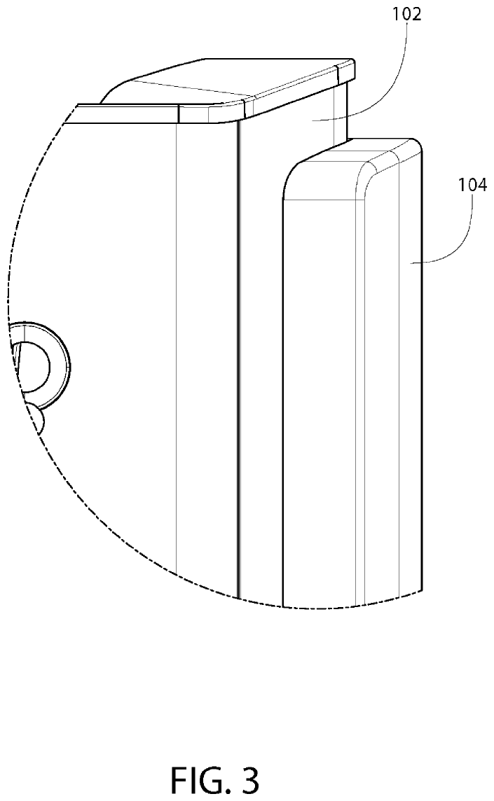

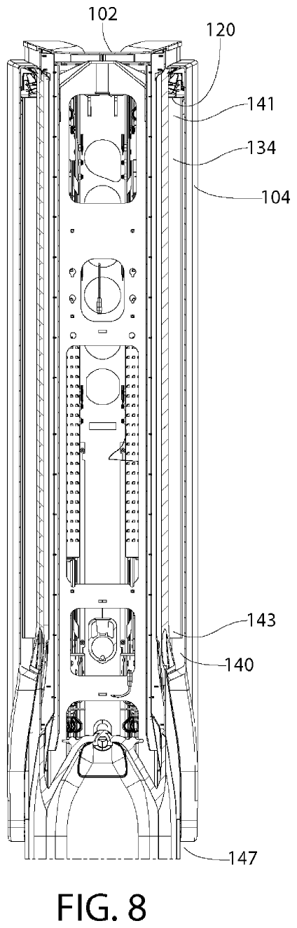

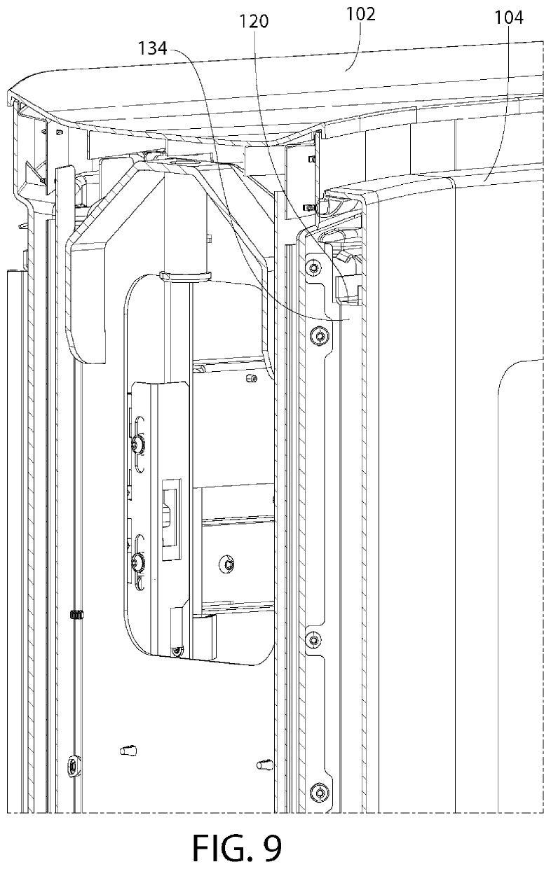

Exemplary embodiments of the present disclosure provide an electric vehicle charging station (EVCS). Referring to FIGS. 1-9, there is shown an EVCS, generally designated 100. EVCS 100 may be configured to provide an electric charge to an electric vehicle via one or more electrical connections. In some embodiments, EVCS 100 provides an electric charge to the electric vehicle via a wired connection, such as a charging cable. In some embodiments, the charging cable is be housed within EVCS 100 or proximate EVCS 100 and is be configured to couple the electric vehicle to EVCS 100. In some embodiments, the charging cable provides power from EVCS 100 to the electric vehicle to charge the battery of the electric vehicle. Alternatively, EVCS 100 provides an electric charge to the electric vehicle via a wireless connection (e.g., wireless charging). In some embodiments, the interior of EVCS 100 houses multiple electrical components that allow EVCS 100 to provide power/charge to an electric vehicle. Like most electrical components, if exposed to conductive liquids (e.g., water) these electrical components may become damaged or defective. For example, if precipitation (e.g., rain) enters the interior space of EVCS 100 and comes into contact with one or more electrical components housed within EVCS 100, EVCS 100 may become damaged or defective and may be unable to adequately deliver charge or power to an electric vehicle.

In some embodiments, EVCS 100 is configured to be installed outdoors, while in other embodiments, the EVCS 100 is configured to be installed indoors. For example, EVCS 100 may be installed outdoors such as within parking lots, parking structures, or road stops, or indoors, such as within building structures (e.g., underground garages). If the EVCS 100 is installed outside, it will be exposed to various types of weather and conditions. For example, EVCS 100 may be exposed to precipitation including rain, snow, sleet, etc. To prevent liquids (e.g., precipitation) from entering the interior of EVCS 100, EVCS 100 includes a drainage system. The drainage system may be comprised of one or more gutters (e.g., gutter 120) configured to collect and direct precipitation that enter EVCS 100 to a drainage port to prevent the liquids from damaging components in the interior space of EVCS 100.

Referring to Figs, 1-4, in some embodiments, EVCS 100 includes frame 102 (e.g., a body or a chassis). In some embodiments, frame 102 includes a front side 113 and a rear side 115, and frame 102 extends from front side 113 to the rear side 115. For example, frame 102 may have a width that extends from the front side 113 to the rear side 115. Frame 102 may include two side surfaces, side surfaces 116 and 117, each extending from front side 113 to rear side 115. Side surfaces 116 may be opposite side surface 117. In some embodiments, side surfaces 116 and 117 each have a width that is the maximum width of frame 102.

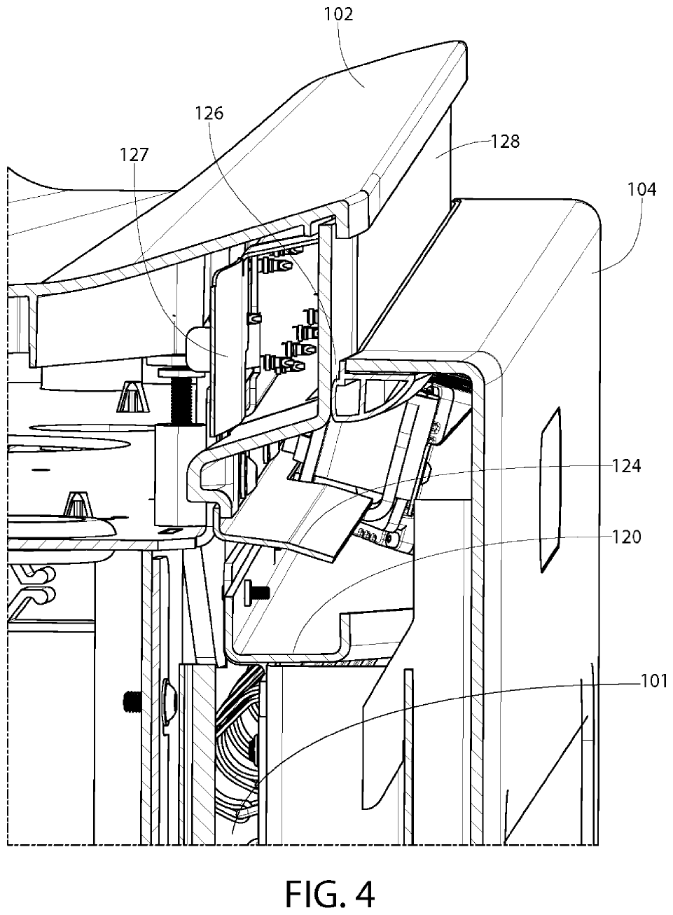

In some embodiments, EVCS 100 includes interior space 101 (best seen in FIG. 4) at least partially defines by the frame 102. In some embodiments, interior space 101 is disposed between front side 113, rear side 115 and side surfaces 116, 117 of frame 102. In some embodiments, interior space 101 houses one or more electrical components. In some embodiments, frame 102 includes base 147 disposed at the bottom of frame 102. For example, base 147 may be disposed proximate a surface on which EVCS 100 is placed on and/or secured to, e.g., a concrete base with anchor bolts. Base 147 may include one or more feet used to level the EVCS 100 to make it stable on the surface.

In some embodiments, frame 102 houses circuitry for charging an electric vehicle. In some embodiments, this circuitry is housed within interior space 101. For example, in some embodiments, frame 102 includes power supply circuitry as well as circuitry for determining a state of a vehicle being charged (e.g., whether the vehicle is connected via the connector, whether the vehicle is charging, whether the vehicle is done charging, the current charge state of the vehicle, etc.). In some embodiments, frame 102 is substantially rigid to provide structure and stability to EVCS 100. For example, frame 102 may be substantially rigid and durable to protect the internal components of EVCS 100 from wind, debris, weather, sunlight, or other conditions and hazards. In some embodiments, frame 102 is substantially comprised of a durable and rigid material to provide stability to EVCS 100 and provide protection to the components disposed within the interior of frame 102 (e.g., interior space 101) and EVCS 100.

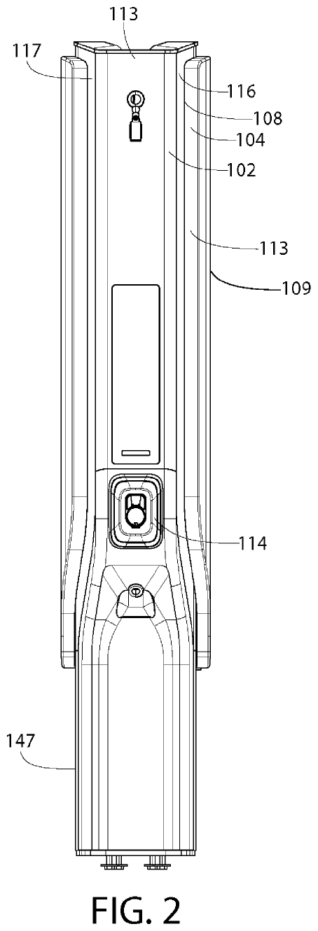

Referring to FIGS. 1 and 2, EVCS 100 may include one or more doors 104 coupled to frame 102. For example, EVCS 100 may include one, two, three, four, or greater than four doors 104 coupled to frame 102. In some embodiments, EVCS 100 includes two opposing doors, one on each side of the EVCS 100. In some embodiments, door 104 is rotatably coupled to frame 102. In some embodiments, doors 104 are also configured to articulate away from frame 102 when they are rotated. For example, door 104 may be rotatably coupled to frame 102 via a hinge (not shown) that is configured to allow doors 104 to articulate away from frame 102. The hinge may couple door 104 to an area proximate front side 113 and/or rear side 115 of frame 102. In some embodiments, doors 104 have a closed position, where access to the interior space is restricted, and an open position, where the interior space can be accessed. In the closed position, doors 104 may not be articulated away from frame 102 and may abut frame 102. When doors 104 are in the closed position, access to interior space 101 is prevented. In the open position, doors 104 may be articulated away from frame 102 thereby providing access to interior space 101. In some embodiments, in the open position, door 104 does not abut frame 102.

In some embodiments, door 104 abuts side surface 116 and/or side surface 117 of frame 102 when door 104 is in the closed position. In some embodiments, door 104 has a size smaller than the overall size of frame 102 such that door 104 is disposed over a portion of frame 102 when door 104 is in the closed position. For example, door 104 may be disposed over a portion of side surface 116 and/or side surface 117. In some embodiments, door 104 abuts frame 102 between front side 113 and rear side 115 when door 104 is in the closed position. For example, door 104 may have a maximum width less than the maximum width of side surface 116 and/or side surface 117 such that door 104 is disposed on a portion of side surface 116 and/or side surface 117 when door 104 is in the closed position. In some embodiments, when door 104 is in the closed position, door 104 covers or encloses all or a substantial portion of interior space 101. In some embodiments, the combination of frame 102 and door(s) 104 define interior space 101.

In some embodiments, door 104 includes top edge 107, bottom edge 111, and side edges 103, 105. When door 104 is in the closed position and abuts frame 102, each of top edge 107, bottom edge 111, and side edges 103, 105 may abut frame 102. In some embodiments, when door 104 is in the closed position, top edge 107, bottom edge 111, and side edges 103, 105 are each substantially perpendicular to side surface 116 and/or side surface 117 of frame 102. Top edge 107 may be opposite bottom edge 111 and top edge 107 may be coupled to bottom edge 111 via side edges 103, 105. In some embodiments, top edge 107, side edges 103, 105, and bottom edge 111 define the bounds (e.g., perimeter) of door 104. In some embodiments, top edge 107 is substantially parallel to bottom edge 111. In some embodiments, at least a portion of side edge 103 is substantially parallel to at least a portion of side edge 105. For example, a majority of side edge 103 may be substantially parallel to a majority of side edge 103. Top edge 107 may be coupled to side edges 103 and 105, which may be coupled to bottom edge 111 to form the boundary (e.g., outer perimeter) of door 104. In some embodiments, bottom edge 111 is proximate to base 147 compared to top edge 107.

In some embodiments, door 104 includes exterior surface 109 and interior surface 108. In some embodiments, exterior surface 109 is opposite interior surface 108. In some embodiments, interior surface 108 faces frame 102 and abuts frame 102 when door 104 is in the closed position. In some embodiments, when door 104 is in the closed position, interior surface 108 is disposed over at least a portion of interior space 101. In some embodiments, the space between exterior surface 109 and interior surface 108 of door 104 is substantially hollow, allowing for ample airflow and cooling of door 104. Alternatively, the space between exterior surface 109 and interior surface 108 may include one or more electrical components, cutouts or windows, cooling mechanisms, airflow pathways, and cameras (e.g., camera 110).

In some embodiments, door 104 includes one or more windows 145 extending through door 104 from interior surface 108 to exterior surface 109. Door 104 may include one or more displays or display screens 106 mounted onto interior surface 108 such that display screen 106 is viewable through exterior surface 109 via window 145. Window 145 may be disposed in door 104 within the boundary formed by top edge 107, bottom edge 111, and side edges 103, 105. In some embodiments, EVCS 100 includes two doors 104, one opposite the other, and each door 104 includes a window 145 and display 106. For example, one door 104 having window 145 and display 106 may be coupled to frame 102 proximate side surface 116 and another door 104 having another window 145 and display 106 may be coupled to frame 102 proximate side surface 117.

Display 106 may be configured to display messages (e.g., media content, advertisements) to users of EVCS 100 (e.g., operators of the electric vehicle) and/or to passersby that are in proximity to EVCS 100. In some embodiments, each display 106 is on a respective door 104 that has a height that is at least 60% of a height of frame 102 or door 104 and a width that is at least 90% of a width of frame 102 or door 104. In some embodiments, door 104 has a height that is at least 3 feet and a width that is at least 2 feet. In some embodiments, display 106 is large compared to frame 102 (e.g., 60% or more of the height of the frame and 80% or more of the width of the frame), allowing display 106 to function as a billboard, capable of conveying information to passersby. Display 106 may also be large compared to door 104, encompassing a majority of door 104.

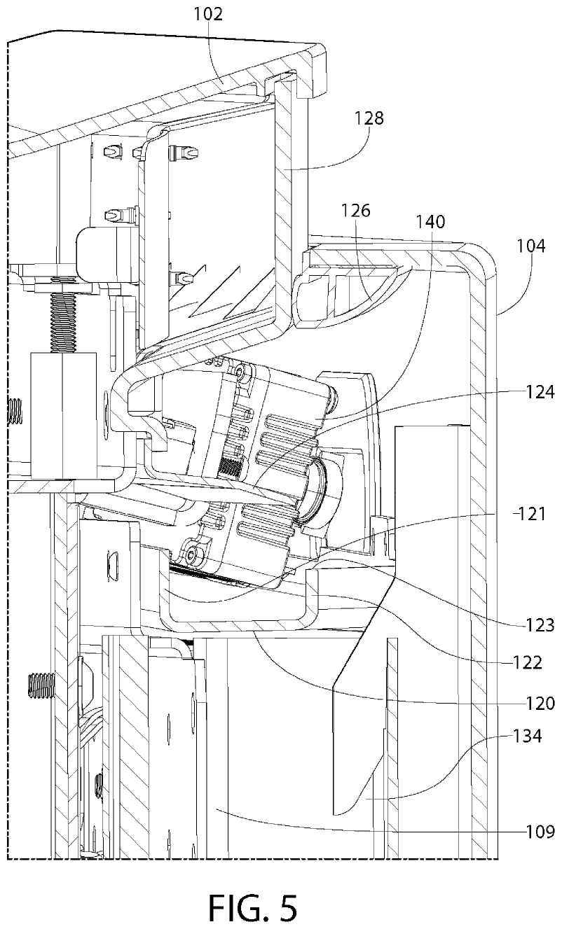

Referring to FIGS. 4-5, in some embodiments, door 104 includes gasket 126. Gasket 126 may be configured to provide a seal between door 104 and frame 102 when door 104 is in the closed position to prevent water or other liquids from entering the interior of EVCS 100, e.g., interior space 101. For example, EVCS 100 may be installed and used in outdoor environments that cause EVCS 100 to be exposed to liquids (e.g., precipitation). In some embodiments, the largest and most susceptible entry point for liquids to enter the interior of EVCS 100 and damage the electrical components stored within EVCS 100 when door 104 is in the closed position is at the junction between door 104 and frame 102. In some embodiments, gasket 126 is configured to substantially prevent water or other liquids from entering the interior of EVCS 100 and damaging the electrical components stored within.

Gasket 126 may be coupled to door 104 along at least a portion of the perimeter of door 104. For example, gasket 126 may be coupled to and extend along top edge 107 and/or side edges 103, 105 of door 104. In some embodiments, gasket 126 is coupled to an interior surface of top edge 107 and/or side edges 103, 105. In some embodiments, gasket 126 also is coupled to and extends along bottom edge 111. Alternatively, gasket 126 may extend along only top edge 107 and a portion of side edges 103, 105. In some embodiments, gasket 126 is coupled to frame 102 and is disposed along at least a portion of frame 102 that abuts door 104 when door 104 is in the closed position. In some embodiments, gasket 126 is comprised of rubber, silicone, nitrile, neoprene, polymer, or any combinations thereof. Gasket 126 may be flexible and malleable, yet durable to withstand harsh conditions, such has heavy precipitation.

In some embodiments, gasket 126 is configured to provide a seal between frame 102 and door 104 when door 104 is in the closed position. For example, gasket 126 may provide a seal between top edge 107 and/or side edges 103, 105 of door 104 when door 104 is disposed against frame 102. In some embodiments, a portion of gasket 126 is disposed between top edge 107 and side edges 103, 105 of door 104 and frame 102 to provide a sufficient seal between door 104 and frame 102 when door 104 is in the closed position. Gasket 126 may be sized and shaped to fit along at least a portion of the perimeter of door 104 and/or a portion of frame 102 to provide a liquid tight seal between door 104 and frame 102 when door 104 is in the closed position. Gasket 126 may include a substantially bulbous end that abuts frame 102 or door 104 and is configured to compress when pushed against frame 102 or door 104 to expand and create a seal when door 104 abuts frame 102.

Referring to FIGS. 4-6, EVCS 100 may include light panel 127 and top wall 128. In some embodiments, light panel 127 is a panel of light emitting diodes (LEDs) configured to output light of varying colors. In some embodiments, light panel 127 is disposed within frame 102, such as near the top of frame 102, and is located behind top wall 128. For example, top wall 128 may be disposed in front of light panel 127 and may be configured to protect light panel 127. In alternative embodiments, EVCS 100 does not include top wall 128 resulting in light panel 127 being exposed. In some embodiments, EVCS 100 does not include top wall 128 and light panel 127 includes a protective cover/barrier to protect light panel 127.

In some embodiments, top wall 128 is substantially vertical and disposed at or near the top of frame 102. Door 104 may abut top wall 128 when door 104 is in the closed position. In some embodiments, EVCS 100 does not include top wall 128 resulting in door 104 abutting light panel 127 when door 104 is in the closed position. In some embodiments, top wall 128 is a diffuser configured to diffuse or scatter light generated by light panel 127, which is disposed behind top wall 128. For example, light generated by the LEDs of light panel 127 may be scattered/diffused by top wall 128 to give a glowing appearance across top wall 128. In some embodiments, top wall 128 is illuminated due to light panel 127 being disposed behind top wall 128. Top wall 128 and light panel 127 may be disposed within frame 102 proximate top edge 107 of door 104 when door 104 is in the closed position. For example, top wall 128 may extend from a portion proximate top edge 107, when door 104 abuts frame 102, to a portion adjacent the top most part of frame 102. In some embodiments, EVCS 100 includes a partial top wall. For example, EVCS 100 may include a partial top wall that does not extend to the top of frame 102.

In some embodiments, a portion of gasket 126 contacts top wall 128 when door 104 is in the closed position. For example, a portion of gasket 126 (e.g., the bulbous portion of gasket 126) proximate top edge 107 may press against top wall 128 and may provide a seal between door 104 and top wall 128 of frame 102 when door 104 is in the closed position. Top wall 128 may have a width extending from front side 113 to rear side 115 of frame 102. In some embodiments, top wall 128 extends along at least a portion of the top of frame 102. For example, top wall 128 may extend at least a portion of the width (e.g., proximate top edge 107) and at least a portion of the height of frame 102 (e.g., proximate side edge 103 and/or side edge 105).

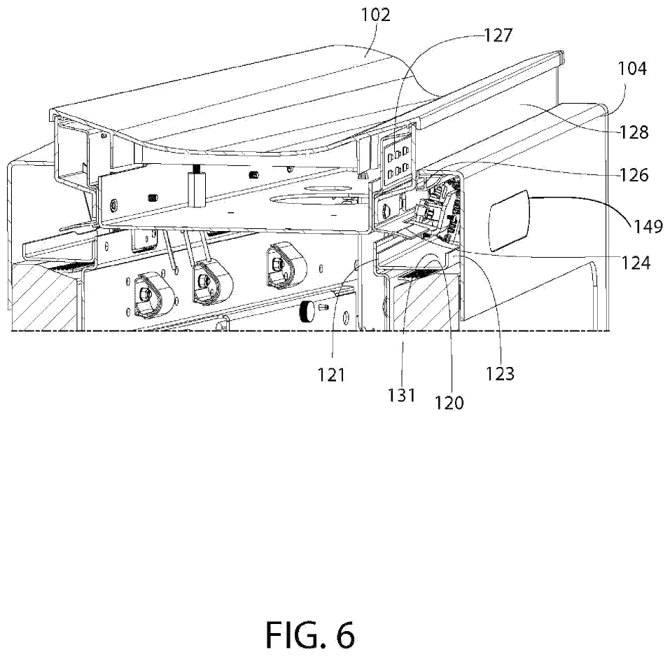

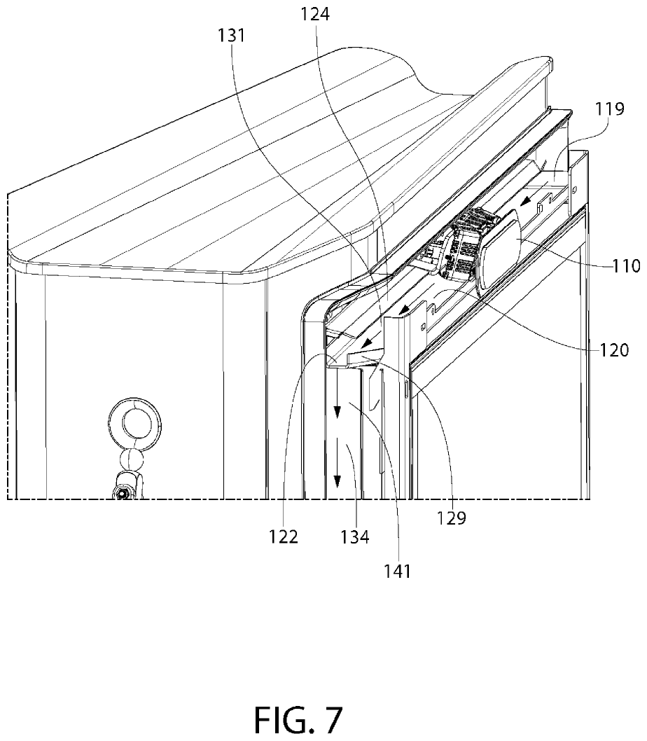

Referring to FIGS. 6-7, in some embodiments, door 104 includes a gutter 120 (e.g., drain). In some embodiments, gutter 120 is configured to collect liquid (e.g., rain, water, precipitation) that bypasses or seeps past gasket 126. For example, gasket 126 may be configured to form a liquid tight seal between door 104 and frame 102 when door 104 is in the closed position. However, gasket 126 may not form a complete seal when door 104 abuts frame 102 or may degrade over time allowing precipitation to enter the interior of EVCS 100 via the junction between door 104 and frame 102. In some embodiments, precipitation enters into the interior of EVCS 100 at the junction of top edge 107 of door 104 and frame 102 (e.g., top wall 128) when door 104 is in the closed position.

In some embodiments, gutter 120 is configured to collect and direct liquid (e.g., precipitation) that seeps through the junction of door 104 (e.g., top edge 107) and frame 102. In some embodiments, gutter 120 is coupled to frame 102 and may be at least partially disposed within door 104 when door 104 is in the closed position. Gutter 120 may be coupled to frame 102 and at least partially disposed within interior space 101. In some embodiments, when door 104 is in the closed position, a portion of gutter 120 extends into door 104 such that a portion of gutter 120 is disposed proximate top edge 107 and a portion of gasket 126. In some embodiments, gutter 120 is substantially parallel to top edge 107 when door 104 is in the closed position. In some embodiments, gutter 120 extends along all or a majority of the width of door 104 when door 104 is in the closed position For example, gutter 120 may extend from an area proximate front side 113 to an area proximate rear side 115. In some embodiments, gutter 120 is coupled to door 104 such that gutter 120 is at least partially disposed within interior space 101 when door 104 is in the closed position. Gutter 120 being coupled to door 104 may result in gutter 120 articulating away from frame 102 when door 104 moves from the closed position to the open position. In some embodiments, EVCS 100 is configured to include two gutters 120 (e.g., one on each side of frame 102 (side surface 116, 117)). However, EVCS 100 may include more than two gutters 120 and may include gutters 120 in various locations or coupled to various components of EVCS 100.

In some embodiments, gutter 120 includes longitudinal ends, each disposed at a terminal end of gutter 120. For example, gutter 120 may include proximal end 119 and distal end 122, and gutter 120 may be configured to extend from proximal end 119 to distal end 122. Gutter 120 may include inner edge 121, outer edge 123, and gutter surface 131 disposed between inner edge 121 and outer edge 123. Inner edge 121 may be opposite outer edge 123 and may be disposed proximate frame 102 (e.g., top wall 128) compared to outer edge 123, which may be disposed proximate door 104. In some embodiments, outer edge 123 is proximate interior surface 108 compared to inner edge 121 when door 104 is in the closed position. Inner edge 121 may be substantially parallel to outer edge 123 along a majority of the length of gutter 120. In some embodiments, gutter 120 has a length that is substantially equal to the width of door 104 or the width of frame 102. Gutter 120 may have a width that allows at least a portion of gutter 120 to extend into door 104. Gutter surface 131 may be substantially perpendicular to inner edge 121 and outer edge 123. Gutter surface 131 may also be substantially parallel to top edge 107, when door 104 is in the closed position. In some embodiments, inner edge 121 and outer edge 123 extend above gutter surface 131 to form a channel that prevents liquid from flowing or spilling out of gutter 120. Gutter 120 may be substantially U-shaped, such as a channel, due to inner edge 121 and outer edge 123 extending upwards from gutter surface 131.

In some embodiments, gutter 120 is disposed within the top third of EVCS 100. For example, gutter 120 may be coupled to frame 102 (or door 104) proximate gasket 126 at the junction of top edge 107 and top wall 128 when door 104 is in the closed position. Gutter 120 may extend into door 104 proximate top edge 107 such that liquid that seeps through the junction of top edge 107 and frame 102 does not pass through a significant portion of EVCS 100 prior to being collected and directed by gutter 120. Since door 104 may include one or more displays 106, the interior of door 104 and/or frame 102 (e.g., interior space 101) may include circuitry, power supplies, or other electronics or electrical systems. Gutter 120 may prevent liquid from flowing into the interior of door 104 and/or frame 102 and thus prevents liquid from accessing the electronics or electrical systems disposed within EVCS 100. Gutter 120 may extend from frame 102 into a portion of door 104 such that an imaginary plane extending through the junction of top edge 107 and top wall 128, when door 104 is coupled to frame 102, and perpendicular to top edge 107, extends through gutter 120 (e.g., between inner edge 121 and outer edge 123). In other words, gutter 120 may be disposed proximate top edge 107, when door 104 is in the closed position, such that gutter 120 can easily collect liquid that flows into EVCS 100 via the junction of top edge 107 and frame 102 (e.g., top wall 128).

In some embodiments, gutter 120 includes tapered portion 129 located at distal end 122 and/or proximal end 119. For example, tapered portion 129 may be formed by outer edge 123 of gutter 120 being angled towards inner edge 121 at distal end 122 and/or proximal end 119. Outer edge 123 being angled towards inner edge 121 at distal end 122 and/or proximal end 119 may result in outer edge 123 tapering towards inner edge 121 at distal end 122 and/or proximal end 119. Distal end 122 and/or proximal end 119 including tapered portion 129 may assist gutter 120 in directing liquid to a desired location (e.g., another gutter, a downspout, a drainage point, an exit point, etc.). In some embodiments, tapered portion 129 is formed by inner edge 121 being angled towards outer edge 123 at distal end 122 and/or proximal end 119. Tapered portion 129 of gutter 120 may be angled downwards (e.g., towards base 147) compared to the rest of gutter 120. Tapered portion 129 being angled downwards may assist in directing liquid captured by gutter 120 to a desired location. In some embodiments, tapered portion 129 of gutter 120 forms a spout to control the direction of the liquid captured by gutter 120 and provide an outlet for the liquid.

In some embodiments, proximal end 119 of gutter 120 is elevated compared to distal end 122 to allow liquid to easily flow from proximal end 119 to distal end 122. For example, proximal end 119 may be disposed proximate top wall 128 compared to distal end 122, resulting in gutter 120 being angled (e.g., slanted) towards distal end 122. Gutter 120 being slanted results in liquid naturally flowing from proximal end 119 to distal end 122 and out of gutter 120 at tapered portion 129. In some embodiments, gutter 120 is angled less than 10 degrees relative to top edge 107 when door 104 abuts frame 102. Gutter 120 may be angled relative to top edge 107 by 0 degrees to approximately 45 degrees, approximately 5 degrees to approximately 35 degrees, approximately 10 degrees to approximately 30 degrees, or approximately 15 degrees to approximately 25 degrees.

In some embodiments, all or a portion of distal end 122 may be angled downwards. For example, distal end 122 of gutter 120 (e.g., tapered portion 129) may be angled downwards towards base 147 such that liquid flowing through distal end 122 flows downward. Distal end 122 of gutter 120 may be angled downwards towards base 147 relative to proximal end 119 by 0 degrees to approximately 45 degrees, approximately 5 degrees to approximately 35 degrees, approximately 10 degrees to approximately 30 degrees, or approximately 15 degrees to approximately 25 degrees.

In some embodiments, proximal end 119 of gutter 120 may be angled downwards towards base 147 such that liquid flowing through proximal end 119 flows downward. Proximal end 119 may include a portion identical to tapered portion 129 to assist proximal end 119 in collecting and directing the flow of the liquid collected by gutter 120. In some embodiments, gutter 120 may include a cover at distal end 122 and/or proximal end 119 or along a portion of gutter 120. The cover may partially or completely cover distal end 122 and/or proximal end 119 to prevent liquid from inadvertently flowing out of gutter 120 and into the interior of door 104 or EVCS 100.

Gutter 120 may include more than one angled portion (e.g., a portion that is angled downwards towards base 147). For example, gutter 120 may include a first angled portion proximate distal end 122 and a second angled portion proximate proximal end 119. Gutter 120 may include an inflection point substantially at the center of the length of gutter 120 such that each portion of gutter 120 extending away from the inflection point is angled downwards towards base 147 resulting in gutter 120 having two angled downward portions. Gutter 120 having two angled downward portions results in gutter 120 collecting liquid and directing it towards either front side 113 or rear side 115.

In some embodiments, frame 102 includes deflector 124. Deflector 124 may be substantially disposed within interior space 101 and may be coupled to top wall 128. For example, deflector 124 may be coupled to top wall 128 such that deflector 124 is disposed under top wall 128. In some embodiments, deflector 124 is coupled to a bottom portion of top wall 128. Alternatively, deflector 124 may be coupled to frame 102 and may be disposed below top wall 128. Deflector 124 may be configured to guide liquid entering EVCS 100 at the junction of door 104 and frame 102 into gutter 120, when door 104 is in the closed position and abuts frame 102. For example, deflector 124 may be disposed above gutter 120 and may be angled downward towards gutter 120 (and base 147) to allow liquid to flow from deflector 124 to gutter 120. In some embodiments, liquid (e.g., water) flows from the junction of door 104 and frame 102 to deflector 124 to gutter 120 due to gravity.

Referring to FIGS. 7-9, EVCS 100 may include downspout 134. Downspout 134 may be coupled to frame 102 and may include proximal end 141 and distal end 143. Downspout 134 may have a length that extends from proximal end 141 to distal end 143. Downspout 134 may have a width that substantially equal to the thickness of door 104 and/or the width of gutter 120. In some embodiments, downspout 134 is coupled to frame 102 such that downspout 134 is substantially perpendicular to at least a portion of gutter 120. Proximal end 141 of downspout 134 may be disposed proximate to gutter 120. For example, proximal end 141 of downspout 134 may be disposed proximate distal end 122 and/or proximal end 119 of gutter 120. In some embodiments, all or a portion of downspout 134 is substantially parallel to at least a portion of side edge 103 and/or side edge 105 when door 104 is in the closed position.

Downspout 134 may be coupled to frame 102 at or proximate front side 113 and/or rear side 115. For example, EVCS 100 may include more than one downspout 134, such as two downspouts 134. In this configuration, one downspout 134 may be coupled to frame 102 at or proximate front side 113 and another downspout 134 may be coupled to frame 102 at or proximate rear side 115. In some embodiments, EVCS 100 includes two downspouts 134 per side surface 116, 117 (resulting in EVCS 100 having four downspouts) such that proximal end 141 of one downspout 134 is disposed proximate distal end 122 of gutter 120 and proximal end 141 of another downspout 134 is disposed proximate proximal end 119 of gutter 120. In some embodiments, EVCS 100 includes up to four downspouts 134, one proximate front side 113 on side surface 116, one proximate rear side 115 on side surface 116, one proximate front side 113 on side surface 117, and one proximate rear side 115 on side surface 117.

In some embodiments, distal end 122 and/or proximal end 119 (e.g., tapered portion 129) directs the flow of liquid from gutter 120 into downspout 134 to allow liquid to flow to from an area proximate distal end 122 and/or proximal end 119 of gutter 120 through downspout 134 to an exit point (e.g., drainage point 140). Downspout 134 may be in fluid communication with gutter 120 thereby allowing liquid to flow from gutter 120 to downspout 134. For example, downspout 134 may be fluidly connected to gutter 120 such that it forms a fluid pathway with gutter 120 for liquid to travel from gutter 120 to downspout 134, as indicated by the arrows in FIG. 7, allowing liquid (e.g., precipitation) to be discharged from EVCS 100. In some embodiments, gutter 120 and downspout 134 are separate components and are not coupled together. Alternatively, gutter 120 and downspout 134 may form a unitary structure. For example, distal end 122 of gutter 120 may be coupled to downspout 134. In some embodiments, distal end 122 is removably coupled to gutter 120. Alternatively, distal end 122 of gutter 120 may form a unitary structure with downspout 134. In some embodiments, downspout 134 is a tube, such as a covered channel, to prevent liquid from deviating away from downspout 134 and into the interior of door 104. However, downspout 134 may be open and liquid may flow down downspout 134 due to gravity and may adhere to downspout 134 to the adhesion and cohesion properties of liquid (e.g., water).

In some embodiments, base 147 of EVCS 100 includes drainage point 140. Drainage point 140 may be located at distal end 143 of downspout 134. Drainage point 140 may provide an exit point for liquid that is flowing from gutter 120 and/or downspout 134. For example, drainage point 140 may be disposed at distal end 143 and may allow liquid to flow from within EVCS 100 to the external environment. Drainage point 140 may be disposed proximate base 147 and/or bottom edge 111 when door 104 is in the closed position. Downspout 134 may be angled to direct liquid from proximal end 141 to distal end 143. For example, distal end 143 may be angled such that distal end 143 is disposed proximate the outer perimeter of frame 102 compared to proximal end 141. In other words, downspout 134 may be angled/slanted away from the center of frame 102 to direct liquid away from the interior of EVCS 100.

In practice, EVCS 100 may be placed outdoors or in a location where it is exposed to different environments and conditions. Further, EVCS 100 may be uncovered resulting in EVCS 100 being exposed to liquids (e.g., water, rain, snow, sleet, liquid from trash, etc.). Liquid may enter the interior of EVCS 100 through the junction of door 104 and frame 102 when door 104 is in the closed position. Gasket 126 may be disposed at the junction of door 104 and frame 102 (e.g., at the junction of top edge 107 and top wall 128) to prevent liquid from entering the interior of EVCS 100. However, gasket 126 may degrade over time or may not form a tight seal, resulting in liquid entering through the junction of door 104 and frame 102 when door 104 is in the closed position. EVCS 100 may include gutter 120 disposed within the interior of EVCS 100, such as within the interior of frame 102, to collect liquid that enters EVCS 100. Gutter 120 may be disposed within the top third of frame 102, proximate top wall 128, such that gutter 120 is configured collect liquid close to where it enters EVCS 100. Gutter 120 may direct and control the flow of the liquid causing it to flow from proximal end 119 to distal end 122 of gutter 120 such that the liquid exits gutter 120 at distal end 122 (e.g., at the tapered portion). In some embodiments, gutter 120 causes liquid to flow to both distal end 122 and proximal end 119.

Liquid exiting gutter 120 may flow into downspout 134, which may be coupled to frame 102. Downspout 134 may extend from an area proximate gutter 120 towards base 147 and may be disposed proximate distal end 122 and/or proximal end 119 of gutter 120 such that liquid flows for distal end 122 and/or proximal end 119 of gutter 120 into downspout 134. Downspout 134 may extend downwards towards base 147 to drainage point 140. Drainage point 140 may be an exit point for liquid to flow from downspout 134 to an area external to EVCS 100, thereby allowing liquid to exit EVCS 100.

Referring to FIGS. 1 and 6-7, EVCS 100 may include one or more cameras 110 configured to capture one or more images of an area proximal to the EVCS 100. Camera 110 may be disposed within interior space 101 and may include a lens pointed through camera opening 149 disposed within door 104. In some embodiments, camera 110 is disposed between top wall 128 and gutter 120. For example, camera 110 may be disposed within interior space 101 such that camera 110 is disposed above gutter 120. Camera 110 may be disposed within a portion of deflector 124 such that deflector 124 includes a cut-out sized and shaped to receive camera 110. Camera 110 may include a cover or shield configured to protect the exterior of camera 110 and direct liquid from the top of camera 110 to deflector 124 and/or gutter 120.

In some embodiments, the one or more cameras 110 are configured to obtain video of an area proximal to the EVCS 100. For example, camera 110 may be configured to obtain a video or capture images of an area corresponding to a parking spot or parking area associated with EVCS 100. Another camera 110 may be configured to obtain a video or capture images of an area corresponding to a parking spot next to the parking spot or parking area of EVCS 100. Camera 110 may be a wide angle camera or a 360° camera that is configured to obtain a video or capture images of a large area proximal to the EVCS 100, including a parking spot of the EVCS 100. In some embodiments, the one or more cameras 110 (or other sensors) may be positioned at different locations on the EVCS 100 than what is shown in the figures.

It will be understood that, although the terms first, second, etc., are, in some instances, used herein to describe various elements, these elements should not be limited by these terms. These terms are only used to distinguish one element from another. For example, a first widget could be termed a second widget, and, similarly, a second widget could be termed a first widget, without departing from the scope of the various described embodiments. The first widget and the second widget are both widget, but they are not the same condition unless explicitly stated as such.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. Further, many components are not necessary and may not be included. For example, the EVCS 100 may not include the camera 110 and/or top wall 128. The embodiments were chosen in order to best explain the principles underlying the claims and their practical applications, to thereby enable others skilled in the art to best use the embodiments with various modifications as are suited to the particular uses contemplated.

1. An electric vehicle charging station comprising:
a frame at least partially defining an interior space;
a door rotatably coupled to the frame to provide access to the interior space when in an open position and to prevent access to the interior space when in a closed position; and
a gutter disposed at least partially within the interior space to divert precipitation away from the electric vehicle charging station.

2. The electric vehicle charging station of claim 1, further comprising a gasket disposed between the door and the frame, where the gasket forms an at least partial seal between at least a portion of the frame and at least a portion of the door in the closed position, and wherein the gutter is configured to divert precipitation that bypasses the gasket away from the electric vehicle charging station.

3. The electric vehicle charging station of claim 2, wherein the gutter includes an inner edge proximate the frame and an outer edge proximate the door.

4. The electric vehicle charging station of claim 3, wherein the inner edge is substantially parallel to the outer edge for a majority of a length of the gutter.

5. The electric vehicle charging station of claim 3, wherein at least one of the inner edge and the outer edge tapers towards one another at a longitudinal end of the gutter.

6. The electric vehicle charging station of claim 2, wherein the gasket is coupled to the door.

7. The electric vehicle charging station of claim 2, wherein the gasket is coupled to the frame.

8. The electric vehicle charging station of claim 2, wherein, in the closed position, a top edge of the door abuts a substantially vertical top wall of the frame.

9. The electric vehicle charging station of claim 8, wherein the top wall of the frame is illuminated.

10. The electric vehicle charging station of claim 8, further comprising a deflector disposed in the interior space under the top wall of the frame to deflect into the gutter any precipitation that enters the interior space from between the top wall of the frame and the top edge of the door when the door is in the closed position.

11. The electric vehicle charging station of claim 10, further comprising:
a gasket coupled to the door and abutting the top wall of the frame when the door is in the closed position, wherein the deflector is coupled to the top wall such that at least a portion of the deflector is disposed between the gasket and the gutter, the deflector configured to deflect the precipitation to the gutter.

12. The electric vehicle charging station of claim 8, wherein the gutter is substantially parallel to the top edge of the door.

13. The electric vehicle charging station of claim 1, further comprising:
a downspout coupled to the frame, the downspout being fluidly connected to the gutter to discharge the precipitation away from the electric vehicle charging station near a base of the frame.

14. The electric vehicle charging station of claim 13, wherein the downspout is substantially perpendicular to the gutter.

15. The electric vehicle charging station of claim 1, further comprising:
a camera disposed within the interior space with a lens pointed through a camera opening in the door.

16. The electric vehicle charging station of claim 15, wherein the camera is in the interior space and above the gutter.

17. The electric vehicle charging station of claim 1, wherein the door comprises:
an interior surface;
an exterior surface opposite the interior surface;
a window extending through the door from the interior surface to the exterior surface; and
a display screen mounted to the interior surface and viewable through the window.

18. The electric vehicle charging station of any of claim 1, wherein the gutter is coupled to the frame.

19. The electric vehicle charging station of claim 1, wherein the gutter is coupled to the door.

20. The electric vehicle charging station of claim 1, further comprising:
an additional door coupled to the frame, the additional door being disposed on an opposite side of the frame to the door.

21. The electric vehicle charging station of claim 1, wherein a proximal end of the gutter is disposed higher than a distal end of the gutter such that the proximal end of the gutter is proximate a top wall of the frame compared to the distal end of the gutter.

22. An electric vehicle charging station comprising:
a frame at least partially defining an interior space, the interior space housing one or more electrical components configured to provide charge to an electric vehicle;
a door rotatably coupled to the frame, the door having a top edge and a side edge, the door having an open position allowing access to the interior space and a closed position preventing access to the interior space;
a gasket disposed along at least a portion of the top edge and a portion of the side edge, wherein the gasket abuts the frame to form a seal between the portion of the top edge and the frame when the door is in the closed position;
a gutter including an outer edge and an inner edge and the gutter extending across at least a portion of a width of the door, the gutter disposed within the interior space and proximate the gasket when the door is in the closed position, the outer edge being tapered towards the inner edge at a distal end of the gutter; and
a downspout coupled to the frame proximate the distal end of the gutter, the downspout being substantially perpendicular to the gutter when coupled to the frame.
